(19) United States
(12) Patent Application Publication
(10) Pub. No.: US 2015/0310561 A1
(43) Pub. Date: Oct. 29, 2015

(54) ASSET MANAGEMENT SERVER, ASSET MANAGING METHOD, AND ASSET MANAGEMENT SERVER PROGRAM

(71) Applicant: OPTiM Corporation, Saga-shi (JP)

(72) Inventor: Shunji SUGAYA, Tokyo (JP)

(21) Appl. No.: 14/582,419

(22) Filed: Dec. 24, 2014

(30) Foreign Application Priority Data
Apr. 24, 2014 (JP) 2014-090722

(51) Int. Cl. G06Q 40/00

(52) U.S. Cl. CPC G06Q 40/12

(57) ABSTRACT

An asset management server 200 has an asset database 250 and an accounting information database 251, and performs an asset management of a user. The asset management server 200 receives purchase information of a product that is purchased by the user, acquires product information included in the purchase information, registers the product as an asset of the user in the asset database 250 based on the received purchase information and the acquired product information, specifies an accounting title of the product based on the acquired product information, and registers the received purchase information and the specified accounting title as accounting information in the accounting information database, the received purchase information and the specified accounting title being associated with each other.

### CROSS-REFERENCE TO RELATED APPLICATION

The present application claims priority to and the benefit of Japanese Patent Application No. 2014-090722 filed on Apr. 22, 2014, the entire contents of which are incorporated herein by reference.

### BACKGROUND

1. (a) Field

The present invention generally relates to an asset management server, an asset managing method, and an asset management server program for performing an asset management of a user regarding an e-commerce on the internet.

2. (b) Description of the Related Art

Today, electric commerce (hereinafter referred to as “e-commerce”) over the internet has continued to expand its market size, and the number of users is continuously increasing. Further, products such as appliances and food have become subjects for transactions of the e-commerce. Furthermore, not only the purchases of products on e-commerce business sites but also transactions between individuals over the internet auctions have been actively performed.

In the e-commerce, since trading information is handled as electronic data, a management such as search and statistical processing of the trading information is easy. Therefore, many e-commerce sites use the recommendation algorithm based on the customers' transaction histories, thereby stimulating the purchase desire of customers and improving sales.

For example, Japanese Patent Application Publication No. 2010-272015 discloses an internet shopping management method for providing an effective recommendation at the time of searching for the product by referring to the purchase history and for promoting the sale of the product.

However, because the accumulation of customer transaction histories contributes to the improvement of the recommendation accuracy of the e-commerce site and functions as a competitive advantage, the transaction histories are accumulated only in the e-commerce site in many cases. Therefore, there is a problem that the user does not effectively perform his or her asset management.

### SUMMARY

An embodiment of the present invention has been made in an effort to easily manage an asset by registering products purchased by a user as the asset and centrally managing the asset on a server accessible by the user, and to enhance user convenience at making accounting books by overall performing an accounting management.

An embodiment of the present invention provides an asset management server, an asset managing method, and an asset management server program for registering products purchased by a user as an asset to centrally manage the products on the internet, and for overall performing an accounting management including making accounting books based on purchase information.

The present invention may provide the following embodiments.

In a first embodiment of the present invention, an asset management server for performing an asset management of a user is provided. The asset management server includes an asset database and an accounting information database. The asset management server further includes a purchase information reception module, a product information acquisition module, an asset registration module, an accounting title specification module, and an accounting information registration module. The purchase information reception module receives purchase information of a product that is purchased by the user, and the product information acquisition module acquires product information included in the purchase information. The asset registration module registers the product as an asset of the user in the asset database, based on the received purchase information and the acquired product information. The accounting title specification module specifies an accounting title of the product based on the acquired product information. The accounting information registration module registers the received purchase information and the specified accounting title as accounting information in the accounting information database, and the received purchase information and the specified accounting title are associated with each other.

According to the first embodiment of the present invention, an asset management server having an asset database and an accounting information database and for performing an asset management of a user can receive purchase information of a product that is purchased by the user, acquire product information included in the purchase information, register the product as an asset of the user in the asset database based on the received purchase information and the acquired product information, specify an accounting title of the product based on the acquired product information, and register the received purchase information and the specified accounting title as accounting information in the accounting information database, the received purchase information and the specified accounting title being associated with each other.

The first embodiment of the present invention relates to the asset management server, but may be applicable to an asset managing method, an asset management server program, and a recording medium in the same manner.

In a second embodiment of the present invention, the asset management server further includes an optical character recognition module configured to receive an image as the purchase information and to recognize a text from the image. The product information acquisition module acquires the product information by extracting the product information from the recognized text.

According to the second embodiment of the present invention, the asset management server according to the first embodiment can receive an image as the purchase information and to recognize a text from the image, and acquire the product information by extracting the product information from the recognized text.

In a third embodiment of the present invention, the product information acquisition module acquires the product information by extracting the product information from an email that is received as the purchase information.

According to the third embodiment of the present invention, the asset management server according to the first or second embodiment can acquire the product information by extracting the product information from an email that is received as the purchase information.

In a fourth embodiment of the present invention, the product information acquisition module acquires information about a manual and a warranty of the product when acquiring the product information, and the asset registration module further registers the acquired information as the asset in the asset database.

According to the fourth embodiment of the present invention, the asset management server according to the first, second, or third embodiment can acquire information about a manual and a warranty of the product when acquiring the product information, and register the acquired information as the asset in the asset database.

In a fifth embodiment of the present invention, a method of managing an asset by an asset management server including an asset database and an accounting information database is provided. The method includes acquiring purchase information of a product that is purchased by a user, registering the product as an asset of the user in the asset database, acquiring product information of the asset, specifying an accounting title of the product based on the acquired product information, and registering the acquired purchase information and the specified accounting title as accounting information in the accounting information database, the acquired purchase information and the specified accounting title being associated with each other.

In a sixth embodiment of the present invention, a recording medium that stores a program for executing an asset managing method on an asset management server including an asset database and an accounting information database is provided. The asset managing method includes acquiring purchase information of a product that is purchased by a user, registering the product as an asset of the user in the asset database, acquiring product information of the asset, specifying an accounting title of the product based on the acquired product information, and registering the acquired purchase information and the specified accounting title as accounting information in the accounting information database, the acquired purchase information and the specified accounting title being associated with each other.

According to an embodiment of the present invention, an asset management server, an asset managing method, and an asset management server program can register products purchased by a user as an asset to centrally manage the products on the internet, and overall perform an accounting management including making accounting books based on purchase information.

### BRIEF DESCRIPTION OF THE DRAWINGS

FIG. 1 is a diagram for explaining an overview of an asset management system according to an embodiment of the present invention.

FIG. 2 is a system block diagram exemplifying an asset management system according to an embodiment of the present invention.

FIG. 3 is a function block diagram of a user terminal, an asset management server, and e-commerce server according to an embodiment of the present invention.

FIG. 4 is a flowchart of a purchased product registering process executed by a user terminal, an asset management server, and an e-commerce server according to an embodiment of the present invention.

FIG. 5 shows an example of an asset registration screen displayed on a user terminal according to an embodiment of the present invention.

FIG. 6 shows an example of an accounting registration screen displayed on a user terminal according to an embodiment of the present invention.

FIG. 7 shows an example of an asset table in an asset database according to an embodiment of the present invention.

FIG. 8 shows an example of an accounting information table in an accounting information database according to an embodiment of the present invention.

### DETAILED DESCRIPTION

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Overview of Asset Management System 1

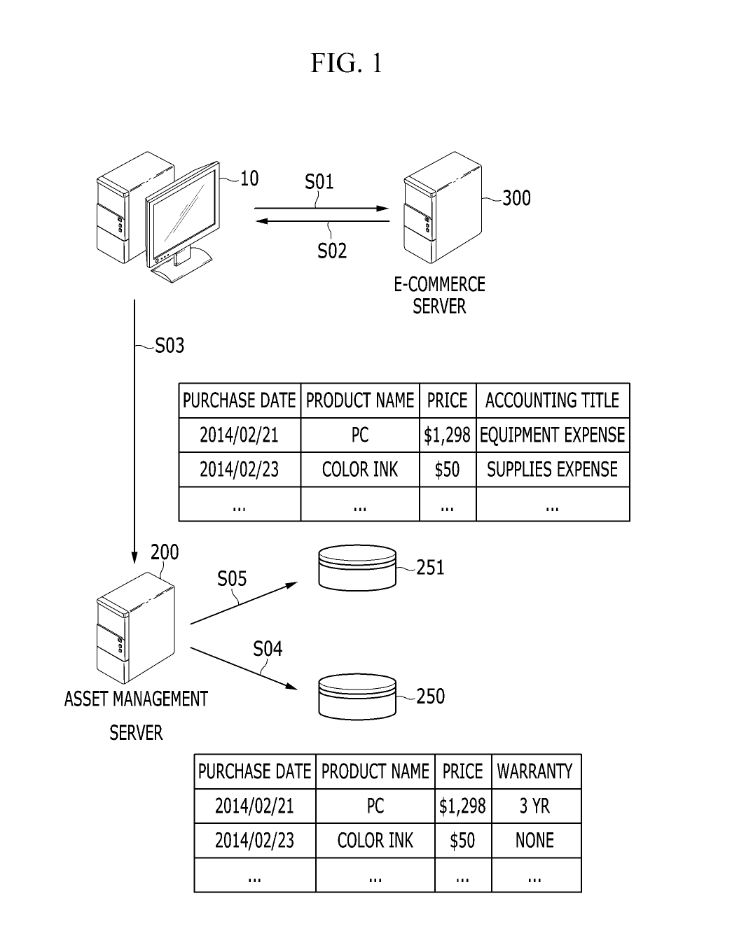

An overview of an asset management system 1 according to an embodiment of the present invention is described with reference to FIG. 1. Referring to FIG. 1, an asset management system 1 includes a user terminal 10, an asset management server 200, an e-commerce server 300.

First, a user performs a communication with the e-commerce server 300 using the user terminal 10, and transmits a purchase request for a product to the e-commerce server 300 (step S01). Here, the e-commerce server 300 is a server that provides the so-called e-commerce service.

Next, the e-commerce server 300 performs the purchase processing of the product based on the purchase request received from the user terminal 10 and executes a payment processing and a shipment processing, and then transmits to the user terminal 10 a detailed purchase information including a notification on completion of the purchase, product information on the product, and a result of the payment processing (step S02).

The user terminal 10 which has received the purchase information sends the purchase information to the asset management server 200 to register the purchased product as an asset (step S03). Here, the asset indicates the user's possessions or rights in a broad sense unlike the so-called accounting asset.

When receiving the purchase information, the asset management server 200 extracts the product information, purchase price, and/or purchase date from the purchase information, and registers them in an asset database 250 as the user's asset (step S04).

Subsequently, the asset management server 200 specifies an accounting title of the product based on the product information, and registers accounting information related to the purchase of the product in an accounting information database 251 (step S05).

In a certain embodiment, the e-commerce server 300 may directly transmit the purchase information to the asset management server 200. In one embodiment, the purchase information may have a string format such as an email or a text file. In another embodiment, the purchase information may be an image of a receipt. In yet another embodiment, the purchase information may be transmitted as an API (Application Program Interface) parameter.

In a certain embodiment, the subject of the asset managed by the asset management server 200 is not limited to the product that is purchased through the e-commerce. For example, the user terminal 10 may take a picture of the receipt and transmit the taken picture to the asset management server 200 as the purchase information, thereby registering the purchased product as the asset.

The above disclosure is the overview of the asset management system 1 according to an embodiment of the present invention.

System Configuration of Asset Management System 1

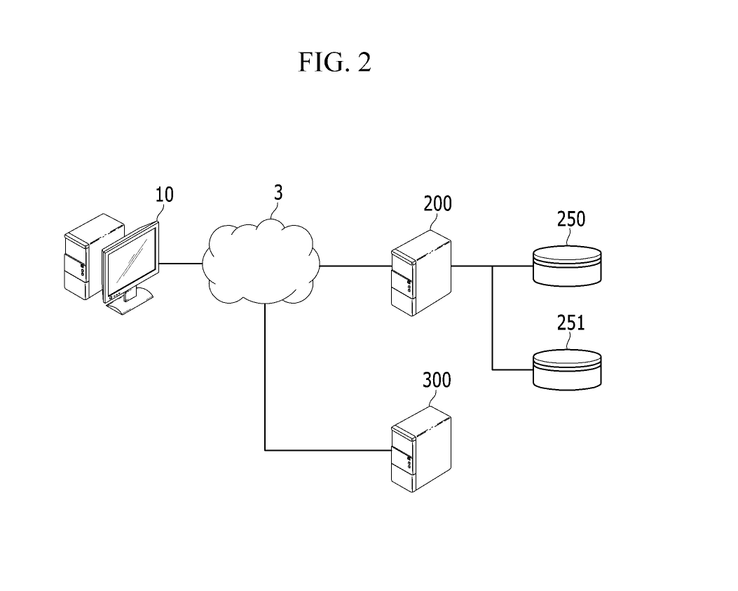

FIG. 2 is a system block diagram exemplifying an asset management system 1 according to an embodiment of the present invention. Referring to FIG. 2, an asset management system 1 includes a public network 3 such as the internet network, a user terminal 10, an asset management server 200, an asset database 250, an accounting information database 251, and an e-commerce server 300. The user terminal 10 is communicatively connected to the asset management server 200 and the e-commerce server 300 via the public network 3. The asset management server 200 stores the asset database 250 and the accounting information database 251 in a storage unit.

The user terminal 10 displays information acquired through the public network. In a certain embodiment, the user terminal 10 may be a general information terminal for receiving an input from a user. In a certain embodiment, the user terminal 10 may be an information device or a phone having a function to be described later. For example, the user terminal 10 may be a personal computer or an information appliance such as a cellular phone, a smart phone, a slate terminal, a netbook terminal, an electronic book reader, an electronic dictionary terminal, a portable music player, or a portable content playback and record player.

The asset management server 200 is a typical server having an asset management function to be described below. In a certain embodiment, the asset database 250 and/or the accounting information database 251 may be stored in a storage unit of a different server that is communicatively connected to the asset management server 200.

The e-commerce server 300 has an electronic commerce functions and may be a typical server.

Description of Each Function

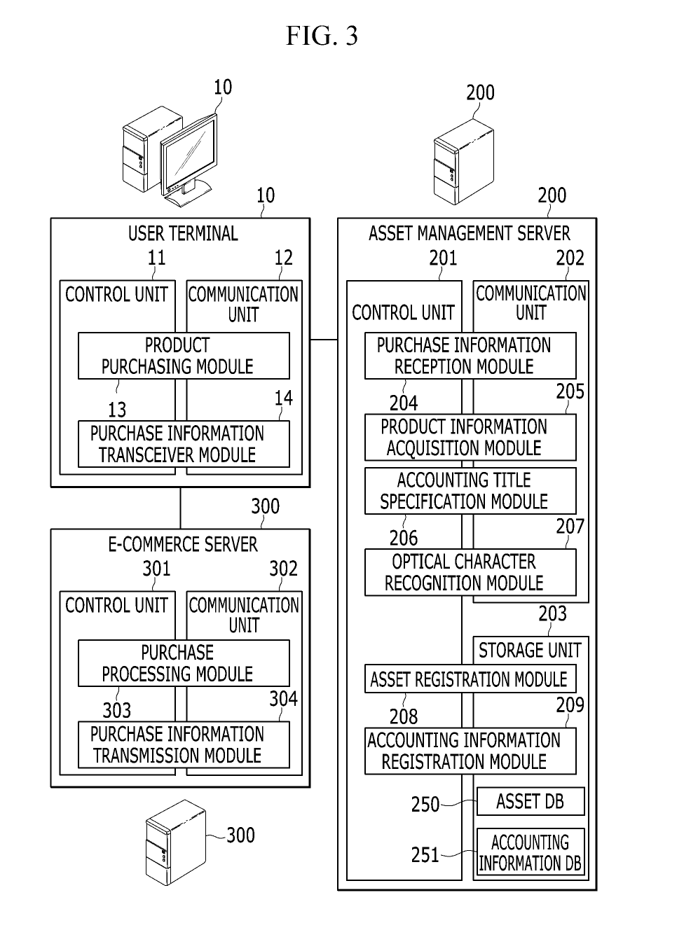

Configuration of each device is described with reference to FIG. 3. The user terminal 10 includes, as a control unit 11, a Central Processing Unit (CPU), a Random Access Memory (RAM), a Read Only Memory (ROM) and the like. The user terminal 10 further includes, as a communication unit 12, a device for enabling a communication with other device, for example a WiFi (Wireless Fidelity) enabled device based on IEEE 802.11.

In the user terminal 10, the control unit 11 reads a predetermined program, thereby implementing a product purchase module 13 and a purchase information transceiver module 14 in cooperation with the communication unit 12.

Similarly to the user terminal 10, the asset management server 200 includes, as a control unit 201, a CPU, a RAM, a ROM, and the like. The asset management server 200 further includes, a communication unit 202, for example, a WiFi enabled device based on IEEE 802.11, or a device for realizing a data communication with other appliance such as a device for enabling a connection by a wire cable or a wireless access point. Additionally, the asset management server 200 further includes, as a storage unit 203 for storing data and files, a data storage unit according to a hard disk, a semiconductor memory, a recording medium, or a memory card. The storage unit 203 includes an asset database 250 and an accounting information database 251.

In the asset management server 200, the control unit 201 reads a predetermined program thereby implementing a purchase information reception module 204, a product information acquisition module 205, an accounting title specification module 206, and an optical character recognition module 207, in cooperation with the communication unit 202. Further, in the asset management server 200, the control unit 201 reads a predetermined program thereby implementing an asset registration module 208 and an accounting information registration module 209, in cooperation with the storage unit 203.

Furthermore, similarly to the user terminal 10, the e-commerce server 300 includes, as a control unit 301, a CPU, a RAM, a ROM and the like. The e-commerce server 300 further includes, a communication unit 202, for example, a WiFi enabled device based on IEEE 802.11, or a device for realizing a data communication with other appliance such as a device for enabling a connection by a wire cable or a wireless access point.

In the e-commerce server 300, the control unit 301 reads a predetermined program thereby implementing a purchase processing module 303 and a purchase information transmission module 304, in cooperation with the communication unit 302.

Purchased Product Registering Process

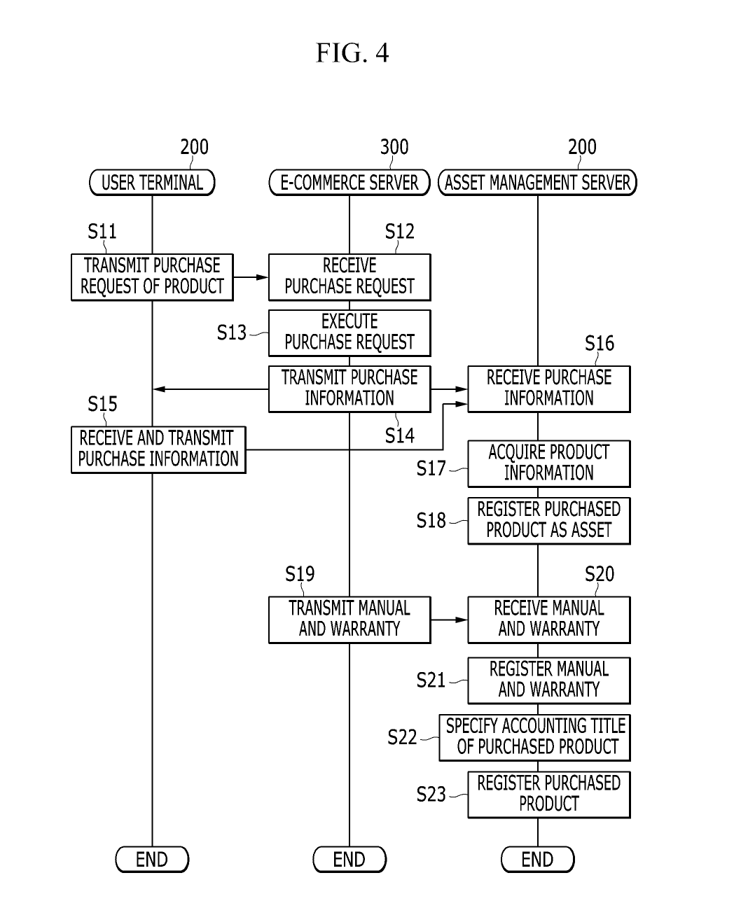

FIG. 4 is a flowchart of a purchased product registering process executed by a user terminal 10, an asset management server 200, and an e-commerce server 300 according to an embodiment of the present invention. The purchased product registering process is described.

First, a product purchasing module 13 of the user terminal 10 communicates with the e-commerce server 300, and transmits a purchase request of a product to be purchased (step S11). In one embodiment, the purchase request includes product information of the product to be purchased, a quantity of the product to be purchased, and payment information.

A purchase processing module 303 of the e-commerce server 300 receives the purchase request (step S12), and executes a purchase processing of the product (step S13).

In a certain embodiment, these product purchasing procedures (steps S11 to S13) are performed by displaying the product information described in HTML (HyperText Markup Language) or the like by using a browsing function provided in the user terminal 10 and transmitting the purchase request of the product when the user browses the product information and decides to purchase the product. In a certain embodiment, the purchase processing of the e-commerce server 300 includes a payment processing and a shipping processing for goods or a license issuing processing for software.

When the purchase processing of the product is completed, a purchase information transmission module 304 of the e-commerce server 300 transmits purchase information of the product to the user terminal 10 and the asset management server 200 (step S14).

In one embodiment, the e-commerce server 300 may not cooperate with other servers including the asset management server 200. In this case, the purchase information transceiver module 14 of the user terminal 10 may first receive the purchase information from the e-commerce server 300, and then transmit the purchase information to the asset management server 200 (step S15).

A purchase information reception module 204 of the asset management server 200 receives the purchase information from the e-commerce server 300 or the user terminal 10 (step S16).

In one embodiment, the subjects of assets managed by the asset management server 200 are not limited to products that are purchased through e-commerce. For example, the user terminal 10 may take a picture of a receipt of the purchased product and transmit to the asset management server 200 the taken picture as the purchase information such that the purchased product can be registered as the asset. In this case, an optical character recognition module 207 performs a character recognition process, i.e., an OCR (Optical Character Recognition) process on an image (i.e., the picture) received by the purchase information reception module 204. Accordingly, subsequent procedures can be executed like a case that the purchase information is transmitted as a text. In another embodiment, the purchase information reception module 204 may receive a purchase confirmation mail as the purchase information. In yet another embodiment, the purchase information reception module 204 may receive a usage history of electronic money or a credit card.

Then, a product information acquisition module 205 of the asset management server 200 acquires product information of the product included in the purchase information (step S17). Since the product information is included in the purchase information, the product information acquisition module 205 may simply analyze the purchase information to extract a product name, a product code, price, product classification and the like. In a general, the purchase information may include product information such as a produce name or a product code, a quantity, a subtotal, a tax, payment information, seller information, and buyer information.

In a certain embodiment, when the product information is extracted from the text into which the receipt is converted by the OCR process or the purchase confirmation mail, a transmission format may be defined in advance. In another embodiment, the product information may be extracted by a pattern matching using a natural language processing based on keywords. For example, after detecting a table from the text or the purchase confirmation mail, the product information acquisition module 205 may extract a part whose index is “product name”, “price”, or the like, or searching the text by using a proprietary name or a general term such as “personal computer (PC)”, “paper”, “ink”, or the like, thereby extracting the product information.

When desiring to acquire detailed product information, the product information acquisition module 205 may search for the product name in search engines or refer to a manufacturer site, thereby acquiring the detailed product information by web mining.

Next, an asset registration module 208 of the asset management server 200 registers the purchased product as the asset in the asset database 250 based on the purchase information and the product information (step S18).

In a certain embodiment, the e-commerce server 300 may transmit a manual and/or a warranty associated with the product name or product code of the purchased product, in response to a request of the asset management server 200 or the like (step S19). The asset management server 200 receives the manual and/or the warranty for the purchased product based on the purchase information (step S20). The asset registration module 208 registers the manual and/or warranty in the asset database 250 in association with the purchased product that is registered as the asset (step S21).

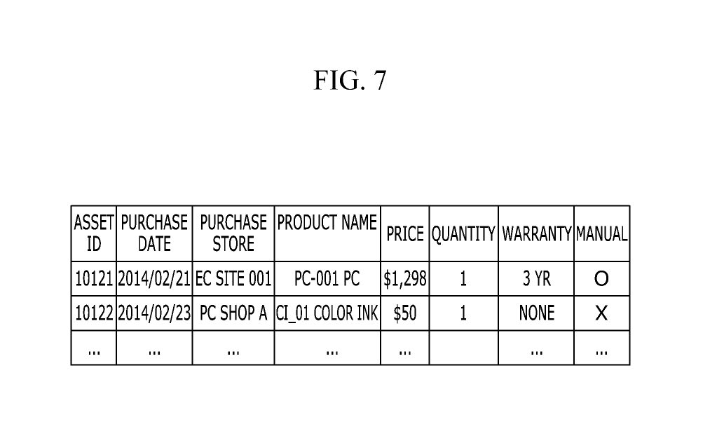

FIG. 7 shows an example of an asset table in an asset database 250 according to an embodiment of the present invention. For each product, purchase date, a purchase store, a product name, price, a quantity, a warranty period, and presence or absence of a manual are stored in the asset table. Then, the past purchase histories are viewable at a glance in the asset table. Further, a unique asset identifier (ID) may be assigned to each asset. The example of FIG. 7 shows the asset table for one user. In a certain embodiment, a user ID may be associated with each asset such that assets of a plurality of users can be managed as one asset table. In a certain embodiment, besides the presence or absence of the manual, a URL (Uniform Resource Locator) or a file name for the manual, or data of the manual may be further stored in the asset table.

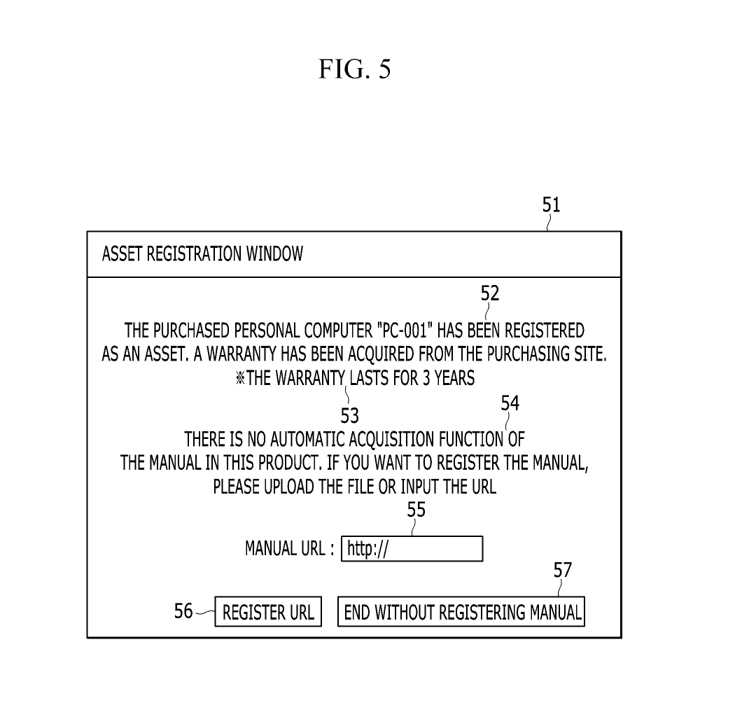

FIG. 5 shows an example of an asset registration screen displayed on a user terminal 10 according to an embodiment of the present invention. A summary 52 of the product that has been registered as the asset is displayed in a window 51. When the warranty exists, a warranty period 53 is displayed. Furthermore, for example, when the manual is not automatically obtained, an input form 55 of information may be displayed, and the manual may be registered by pressing a registration button 56. Pressing an end button 57 may terminate the process without registering the information. This example shows the registration of the manual. However, if there is an item that fails to be obtained or an item to be modified, the registration of the item may be similarly performed.

After the asset registration is completed, an accounting title specification module 206 of the asset management server 200 specifies an accounting title for the purchased product (step S22).

Regarding the accounting title, since a debit account is uniquely determined by an item or type of the product, the debit account may be determined with reference to the product name or the product category. In the case that the user directly specifies the accounting title, the specified accounting title may be used. The accounting titles may be stored in the storage unit by listing or database, and may be used when the accounting title of the product is specified for the user or other users. Since credit accounts are different for each user or each purchased product, the credit account may be determined with reference to the payment information included in the purchase information.

An accounting information registration module 209 of the asset management server 200 registers the purchase date, the product name, the price, the accounting title and the like for the purchased product in an accounting information database 251 (step S23). As a result, contents of the accounting information database 251 can be available as accounting books.

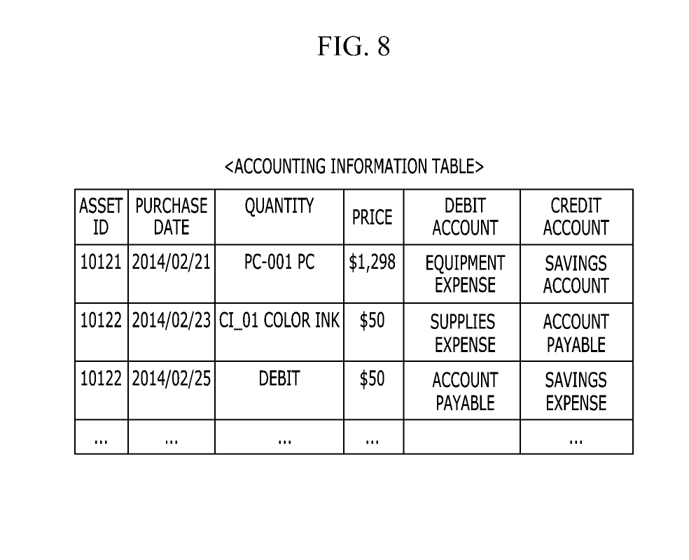

FIG. 8 shows an example of an accounting information table in an accounting information database 251 according to an embodiment of the present invention. The purchase date, the product summary, the price, the debit account, and the credit account are associated with each other and are stored in the accounting information table. Further, the credit account may be savings account in case of a bank transfer, or may be account payable in case of a credit card usage. Furthermore, the accounting items may be associated with an asset ID of the corresponding asset, and the asset ID may be referred for each accounting item.

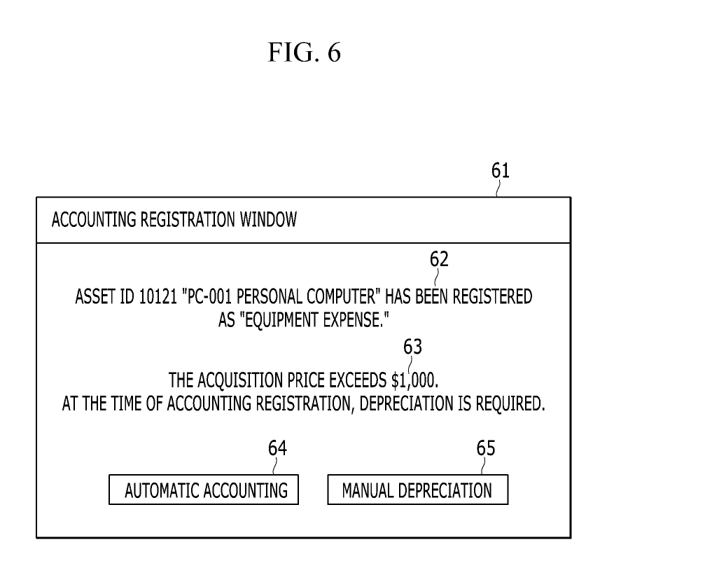

FIG. 6 shows an example of an accounting registration screen displayed on a user terminal 10 according to an embodiment of the present invention. A summary 62 of the asset on which the accounting registration is performed is displayed in a window 61. Further, if there is anything special to report, the report may be displayed as a message 63, and the user may press any one of buttons 64 and 65. In this example, when acquisition price exceeds $1,000, it is notified that a depreciation process is required. The button 64 indicates an automatic accounting process, and the button 65 indicates a manual depreciation process.

The above disclosure is the procedure of the purchased product registering process executed by the user terminal 10, the asset management server 200, and the e-commerce server 300.

The above-described means and functions are realized by reading and executing a predetermined program by a computer (including a CPU, an information processing apparatus, and various terminals). The program is recorded in a (non-transitory) computer-readable recording medium, for example, a flexible disk, a CD (e.g., a CD-ROM or the like) and a DVD (e.g., a DVD-ROM, a DVD-RAM, or the like). In this case, the program is read from the recording medium by a computer and transmitted to an internal storage unit or an external storage unit to be stored and executed. Further, the program may be pre-stored in a storage unit (recording medium) such as a magnetic disk, an optical disk, or an optical magnetic disk and transmitted from the recording medium to a computer through a communications line.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. An asset management server for performing an asset management of a user, the asset management server comprising:
an asset database;
an accounting information database;
a purchase information reception module configured to receive purchase information of a product that is purchased by the user;
a product information acquisition module configured to acquire product information included in the purchase information;
an asset registration module configured to register the product as an asset of the user in the asset database, based on the received purchase information and the acquired product information;
an accounting title specification module configured to specify an accounting title of the product based on the acquired product information; and
an accounting information registration module configured to register the received purchase information and the specified accounting title as accounting information in the accounting information database, the received purchase information and the specified accounting title being associated with each other.

2. The asset management server of claim 1, further comprising an optical character recognition module configured to receive an image as the purchase information and to recognize a text from the image,
wherein the product information acquisition module acquires the product information by extracting the product information from the recognized text.

3. The asset management server of claim 1, wherein the product information acquisition module acquires the product information by extracting the product information from an email that is received as the purchase information.

4. The asset management server of claim 1, wherein the product information acquisition module acquires information about a manual and a warranty of the product when acquiring the product information, and
the asset registration module further registers the acquired information as the asset in the asset database.

5. A method of managing an asset by an asset management server including an asset database and an accounting information database, the method comprising:
acquiring purchase information of a product that is purchased by a user;
registering the product as an asset of the user in the asset database;
acquiring product information of the asset;
specifying an accounting title of the product based on the acquired product information; and
registering the acquired purchase information and the specified accounting title as accounting information in the accounting information database, the acquired purchase information and the specified accounting title being associated with each other.

6. The method of claim 5, further comprising receiving an image as the purchase information and recognizing a text from the image,
wherein acquiring the product information comprises acquiring the product information by extracting the product information from the recognized text.

7. The method of claim 5, wherein acquiring the product information comprises acquiring the product information by extracting the product information from an email that is received as the purchase information.

8. The method of claim 5, further comprising:
acquiring information about a manual and a warranty of the product when acquiring the product information; and
registering the acquired information as the asset in the asset database.

9. A recording medium that stores a program for executing an asset managing method on an asset management server including an asset database and an accounting information database, the asset managing method comprising:
acquiring purchase information of a product that is purchased by a user;
registering the product as an asset of the user in the asset database;
acquiring product information of the asset;
specifying an accounting title of the product based on the acquired product information; and
registering the acquired purchase information and the specified accounting title as accounting information in the accounting information database, the acquired purchase information and the specified accounting title being associated with each other.

10. The recording medium of claim 9, wherein the asset managing method further comprises receiving an image as the purchase information and recognizing a text from the image, and
wherein acquiring the product information comprises acquiring the product information by extracting the product information from the recognized text.

11. The recording medium of claim 9, wherein acquiring the product information comprises acquiring the product information by extracting the product information from an email that is received as the purchase information.

12. The recording medium of claim 9, wherein the asset managing method further comprises:
acquiring information about a manual and a warranty of the product when acquiring the product information; and
registering the acquired information as the asset in the asset database.
